(19) United States
(12) Patent Application Publication
(10) Pub. No.: US 2016/0314205 A1
(43) Pub. Date: Oct. 27, 2016

(54) GENERATING A DISCOVERY PAGE DEPICTING ITEM ASPECTS

(71) Applicant: eBay Inc., San Jose, CA (US)

(72) Inventors: Harrison Maxwell Davis, Demarest, NJ (US); Tao Peng, Roseland, NJ (US); Stephen Neola, Jersey City, NJ (US); Stephen Wu, New York, NY (US); Hyo Chung, New York, NY (US)

(21) Appl. No.: 14/695,139

(22) Filed: Apr. 24, 2015

(51) Int. Cl. G06F 17/30

(52) U.S. Cl. CPC G06F 17/30864; G06F 17/30598; G06F 17/30554; G06F 17/3053

(57) ABSTRACT

In various example embodiments, a system and method for generating a discovery page that depicts item aspects are presented. A query that includes an identifier of an item is received from a client device. A category of items that includes the item described in the query is identified using the identifier of the item. One or more aspects that correspond to a group of items included in the category of items are determined. Item listings for the group of items from the category of items are accessed. A discovery page that depicts the accessed item listings of the group of items in relation to the one or more aspects is generated. Display of the generated discovery page is caused.

### TECHNICAL FIELD

Embodiments of the present disclosure relate generally to data processing and, more particularly, but not by way of limitation, to generating a discovery page that depicts item aspects.

### BACKGROUND

Conventionally, a user may receive a recommendation for an item listing while searching for an item or browsing an item page.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram illustrating components of the aspect discovery system, according to some example embodiments.

FIGS. 3-5 are flowcharts illustrating operations of the aspect discovery system in performing a method of causing display of a discovery page, according to some example embodiments.

FIGS. 6-7 are diagrams illustrating an example user interface that includes a discovery page, according to some example embodiments.

FIG. 8 is a block diagram illustrating representative software architecture, which may be used in conjunction with various hardware architectures herein described.

FIG. 9 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, a system presents a user with a discovery page that enables the user to view item listings across multiple product dimensions or aspects in response to an item query submitted by the user. The system accomplishes this by identifying a category of items using the item query submitted by the user. Then, the system determines the most popular aspects for items within category of items. The aspects represent certain features or attributes of the items within the category of items. Once the most relevant aspects for the items are determined, the item listings for items that feature those aspects are retrieved. Also, the item listings are presented within the discovery page.

The system also presents to the user a discovery page from within an item page. The system identifies aspects about the item featured in the item page and then identifies other related items using the various aspects about the item. Moreover, the related items may be similar to the featured item within the item page, but differ with respect to the featured item based on one or more aspects.

These features provide the user with the technological solution of quicker access to data because relevant product dimensions are brought to the attention of the user within the discovery page.

Further, one or more of the methodologies discussed herein may obviate a need for extraneous or superfluous web browsing from the user, which has the technical effect of reducing computing resources used by one or more devices within the system. Examples of such computing resources include, without limitation, processor cycles, network traffic, memory usage, storage space, and power consumption.

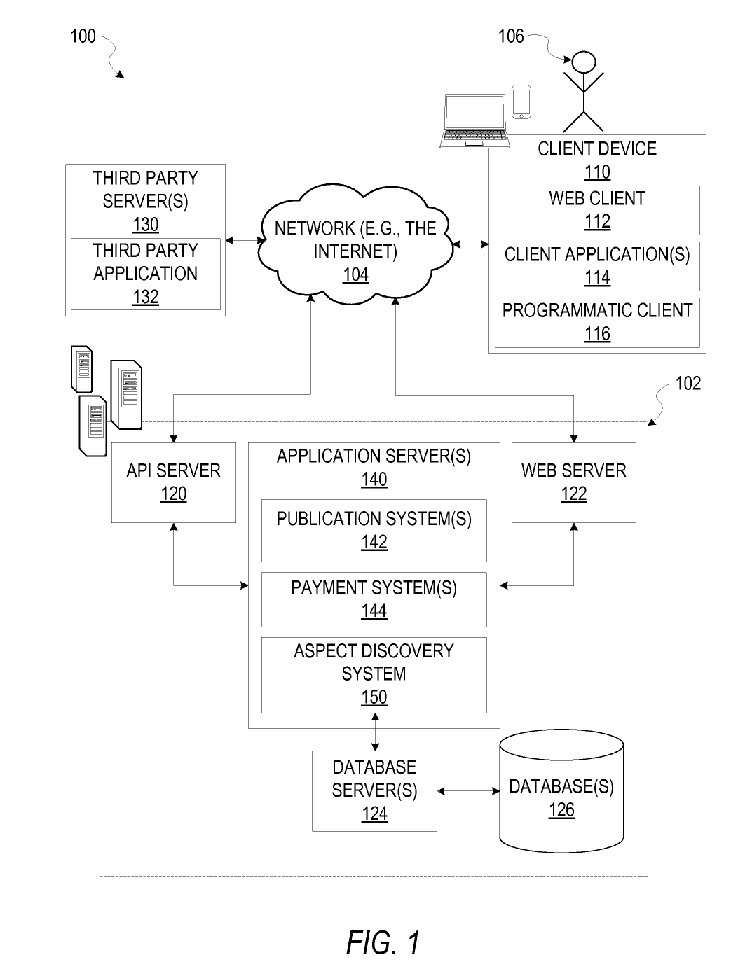

With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), an application 114, and a programmatic client 116 executing on client device 110.

The client device 110 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, wearables, smart watches, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment, etc.). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

An application program interface (API) server 120 and a web server 122 are coupled to, and provide programmatic and web interfaces respectively to, one or more application servers 140. The application servers 140 may host one or more publication systems 142 and payment systems 144, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 142. The databases 126 may also store digital item information in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication systems 142 may provide a number of publication functions and services to users 106 that access the networked system 102. The payment systems 144 may likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

The aspect discovery system 150 may provide functionality operable to generate a discovery page that enables the user to view item listings across multiple product dimensions or aspects in response to an item query submitted by the user. In some example embodiments, the aspect discovery system 150 communicates with the publication systems 142 (e.g., accessing item listings) and payment system 144. In an alternative embodiment, the aspect discovery system 150 may be a part of the publication system 142.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, payment system 144, and aspect discovery system 150 could also be implemented as standalone software programs, which do not necessarily have networking capabilities.

The web client 112 may access the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

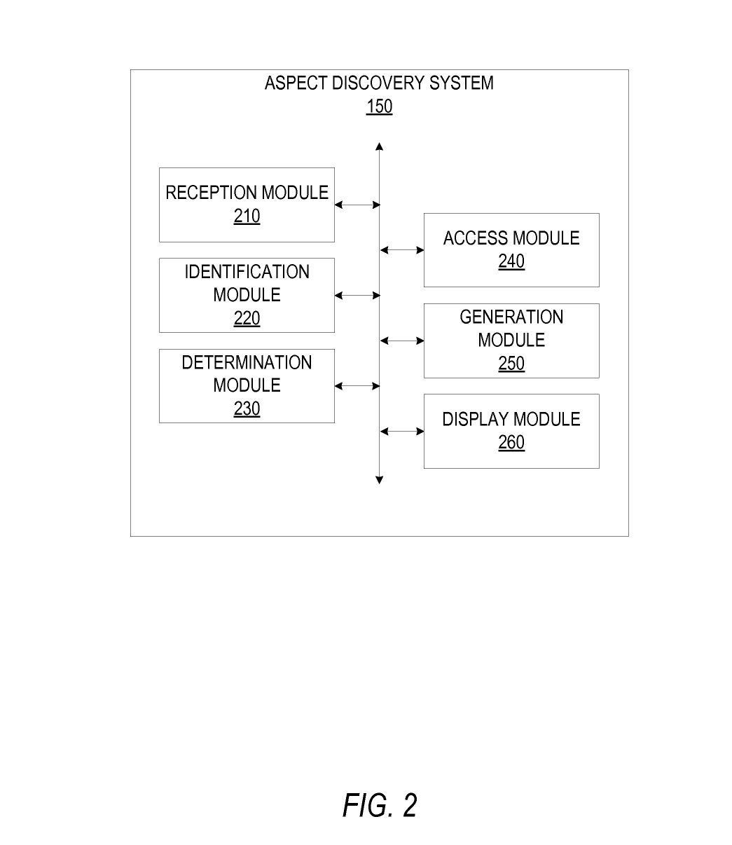

FIG. 2 is a block diagram illustrating components of the aspect discovery system 150, according to some example embodiments. The aspect discovery system 150 is shown as including a reception module 210, an identification module 220, a determination module 230, an access module 240, and a generation module 250, and a display module 260 all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The reception module 210 is configured, in some embodiments, to receive information from a client device (e.g., device 110) operated by a user. In various example embodiments, the reception module 210 is configured to receive a query that includes an identifier of an item from a client device. The identifier of the item may include a description of the item. Also, the identifier of the item may include an identification number that uniquely identifies the item. As such, the query from the client device will describe certain attributes or characteristics of the item. In some instances, the described attributes or characteristics that describe to the item and only describe certain features of that item. In other instances, the described attributes or characteristics are broad and may apply to a category of items.

In various example embodiments, the reception module 210 is further to receive a request to view an item page for the item described in the query, as further explained below.

In various example embodiments, the identification module 220 is configured to identify, using the identifier of the item, a category of items that includes the item described in the query. The category of items may be selected from a set of predetermined categories. For example, the item described in the query may belong to more than one of the predetermined categories. Each of the predetermined categories may represent an assortment of items. Also, in some instances, the identifier of the item may fit in more than one category. Therefore, the identification module 220 is further to select the category of items that includes the item described in the query from among the predetermined categories. In some embodiments, the category of items is identified based on user popularity or on a number of user views. For instance, the identification module 220 is further to determine that at least one item listing from the category of items received at least a predetermined threshold number of previous user views. In some instances, the category of items is indicated in the identifier of the item. For example, if the user enters search terms for “Michael Kors handbags,” the term “handbags” may be identified by the identification module 220 as the category of items.

In various example embodiments, the determination module 230 is configured to determine one or more aspects that correspond to a group of items included in the category of items. The one or more aspects describe certain features or attributes within the category of items that is most popular or receives the most user views. In other words, the one or more aspects represent popular aspects within the category of items. To accomplish this, in some instances, the determination module 230 is further to determine that the item listings for the group of items received a greater number of previous user views as compared to item listings of items outside of the group of items. The one or more aspects may indicate certain common features or attributes shared by the items included in the group of items. For example, the aspects may indicate a specific style for the items included in the group of items. Or the aspects may indicate a certain name brand for the items included in the group of items. The aspects may also indicate a certain color for the item included in the group of items.

In various example embodiments, the determination module 230 is further configured to determine a restricted aspect based on the item described in the query. For example, if the item described in the query is a shoe item, then the determination module 230 is further to determine that shoe size is a restricted aspect. This is because the user that submitted the query would not be interested in viewing or discovering other shoes in different sizes. Therefore, the determined restrict aspect is prevented from being displayed in the discovery page.

In various example embodiments, the access module 240 is configured to access item listings of the group of items from the category of items. In some instances, the item listings are published by a publication server (e.g., publication system 144) and stored in a database maintained by a database server (e.g., database 126 and database server 124). Accordingly, the access module 240 is further to access the item listings from the database.

In various example embodiments, the generation module 250 is configured to generate a discovery page that depicts the accessed item listings of the group of items in relation to the one or more aspects. In other words, the discovery page is organized in a manner that conveniently displays how each of the items from the group of items relates to the one or more aspects. In this regard, the generation module 250 is further to arrange the accessed item listings of the group of items in the discovery page based on the one or more aspects.

In various example embodiments, the display module 260 is configured to cause display of the generated discovery page on the client device. In some embodiments, the display module 260 displays the generated discovery page within a search results page. Alternatively, the display module 260 displays the generated discovery page within an item page, as further explained below.

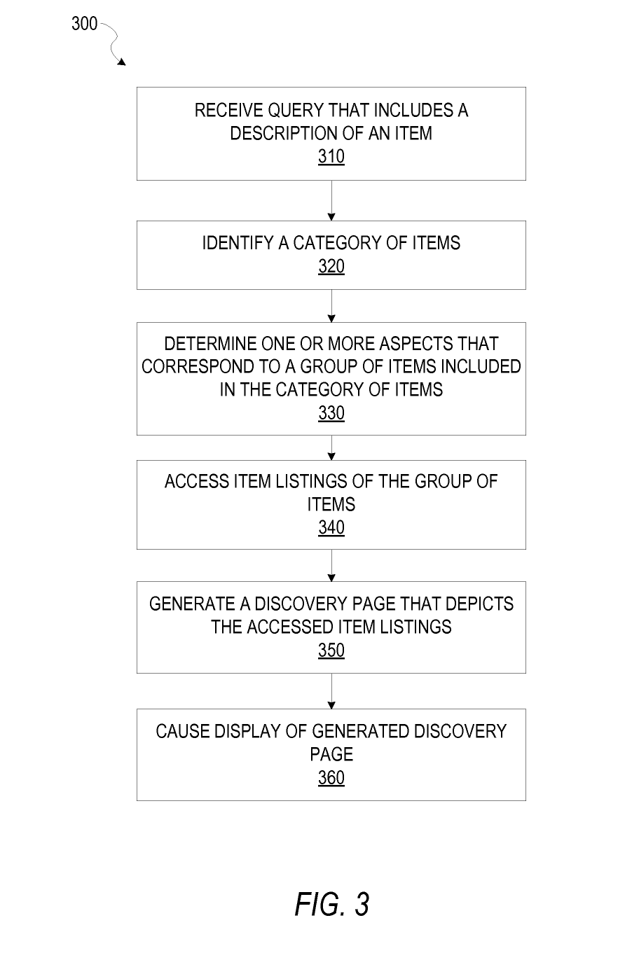

FIGS. 3-5 are flowcharts illustrating operations of the aspect discovery system 150 in performing a method 300 of causing display of a discovery page, according to some example embodiments. Operations in the method 300 may be performed by the aspect discovery system 150, using modules described above with respect to FIG. 2. As shown in FIG. 3, the method 300 includes operations 310, 320, 330, 340, 350, and 360.

At operation 310, the reception module 210 receives a query that includes an identifier of an item. The query that includes the identifier of the item will describe certain attributes or characteristics of the item. In some instances, the described attributes or characteristics are specific to the item and only describe certain features of that item. In other instances, the described attributes or characteristics are general and may apply to a variety or a collection of items.

At operation 320, the identification module 220 identifies a category of items using the identifier of the item received at operation 310. In some instances, the category of items in some instances is selected by the identification module 220 from a set of predetermined categories. The predetermined categories may each indicate an assortment of items. Example categories include: “handbags,” “cars,” “watches,” and the like. In some instances, the identifier of the item may indicate or belong in more than one category. Also, the identifier of the item describes an item that belongs in more than one category. For example, a description for “Michael Kors products” may belong in the category “handbags,” “shoes,” and “watches.” Therefore, in some instances, the identification module 220 is further to select a most popular category, or a category with items that received a predetermined threshold number of previous user views. In other words, the identification module 220 is further to determine that at least one item listing from the category of items received at least the predetermined threshold number of previous user views.

At operation 330, the determination module 230 determines one or more aspects that correspond to the group of items included in the category of items. The one or more aspects describe certain features or attributes of items within the category of items that receives the most user views. To accomplish this, in some instances, the determination module 230 is further to determine that the item listings for the group of items received a greater number of previous views as compared to item listings of items outside of the group of items. Example aspects include: brand, color, type, style, size, and the like. In further embodiments, a size of the group of items may vary based on a size of the discovery page. For instance, the discovery page may only have enough room to display three items. Therefore, the determined aspects may correspond to the top brands within the category of items, or the top colors within the category of items. For example, “Michael Kors” may be the top brand for the item category of “handbags.”

As part of the operation 330, the determination module 230 is further to determine a restricted aspect based on the item described in the query.

At operation 340, the access module 240 accesses item listings of the group of items that correspond to the determined one or more aspects. Moreover, the access module 240 in some instances is further to avoid item listings of items that have the restricted aspect as an attribute. For example, the access module 240 may avoid access to item listings for shoes that differ in size compared to one described in a query.

At operation 350, the generation module 250 generates the discovery page that depicts the accessed item listings.

At operation 360, the display module 260 causes display of the generated discovery page. In some instances, the display module 260 causes display of the generated discovery page within a search results page for the query received at operation 310.

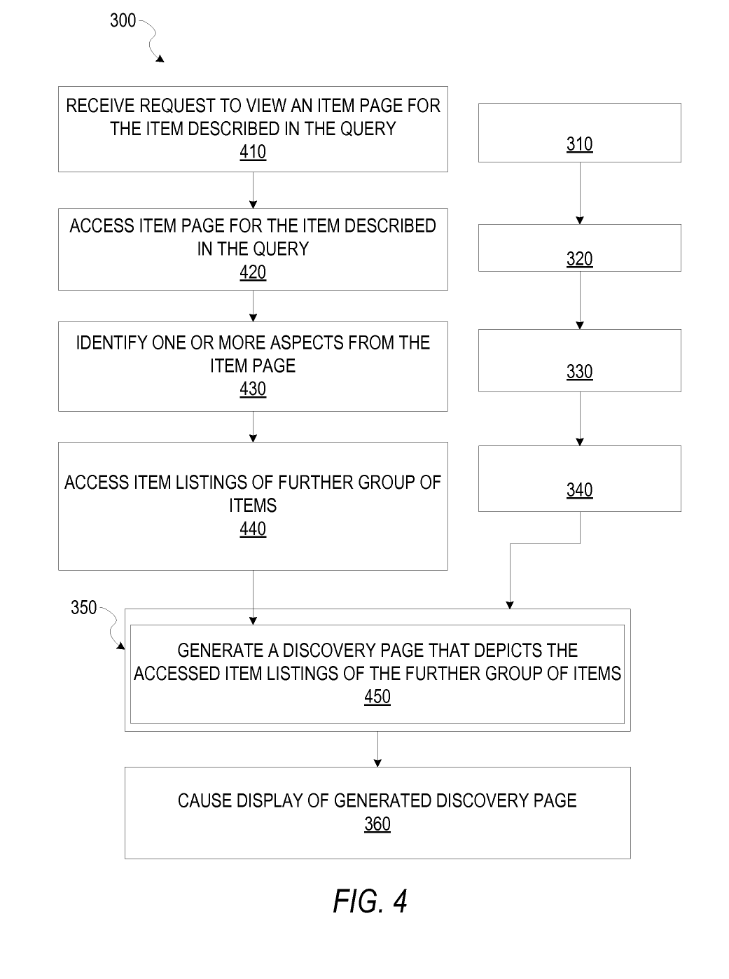

At shown in FIG. 4, the method 300 includes the operations 410, 420, 430, 440 and 450. Moreover, each of the operations 410, 420, 430, and 440 are performed prior to the operation 350. Whereas the operation 450 is included as part of the operation 350.

At operation 410, the reception module 210 receives a request to view an item page for the item described in the query. In some instances, a link to the item page will appear on a search results page that is displayed in response to the query received from the client device at operation 310. Therefore, the reception module 210 receives the request from the client device upon activation of the link on the search results page displayed in response to the query.

At operation 420, the access module 240 accesses an item page for the item described in the query. The item page for the item described in the query may include a description of the item and a picture of the item. The item page for the item may also include various controls that allow the user to purchase the item from the item page.

At operation 430, the identification module 220 identifies one or more aspects about the item from the item page (e.g., a seed item). For instance, the description from the item page about the seed item can indicate the one or more aspects about the seed item. Moreover, if the item page is tagged or includes certain labels to describe the seed item from the item page, each of the labels or tags can be identified by the identification module 220 as an aspect about the seed item from the item page. Example aspects about the seed item include: a color of the seed item, size of the seed item, a function of the seed item, a brand name of the seed item, and the like.

At operation 440, the access module 240 accesses item listings of a further group of items that correspond to the one or more aspects about the seed item from the item page. In some embodiments, the access module 240 will retrieve or access item listings for items that share most of the aspects with the seed item in the item page. However, the items from the accessed item listings may differ from the seed item by one or two aspects. For example, if the seed item is for a navy polo shirt, the access module 240 may identify item listings for other polo shirts that come in different colors. As another example, if the seed item is for the navy polo shirt, the access module 240 may identify item listings for similar types of shirts such as collared shirts or v neck shirts.

At operation 450, the generation module 250 generates a discovery page that depicts the accessed item listings of the further group of items. Subsequently, at operation 360, the display module 260 is further to cause display of the discovery page that depicts the accessed item listings of the further group of items. Moreover, the display module 260 causes display of the discovery page as part of the item page for the item described in the query, or within the item page for the item page described in the query.

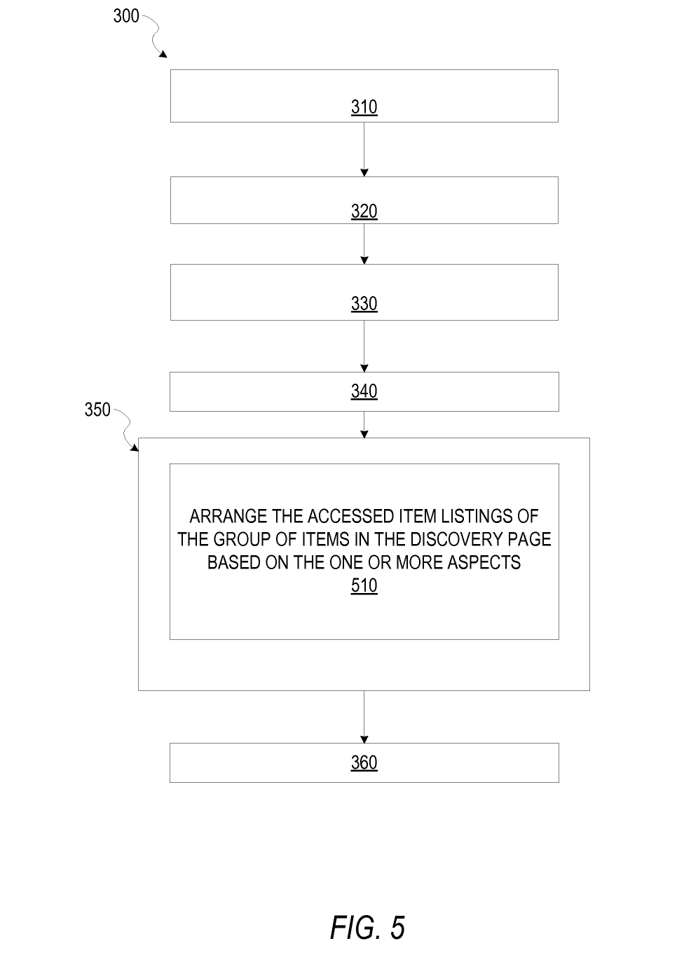

As shown in FIG. 5, the method 300 includes operation 510. Moreover, the operation 510 is included in the operation 350.

At operation 510, the generation module 250 arranges the accessed item listings of the group of items in the discovery page based on the one or more aspects. In some embodiments, the generation module 250 is to represent each of the one or more aspects as a section within the discovery page. Further, within each of the sections are items that correspond to that respective or particular aspect. Therefore, in some instances, the generation module 250 will generate the discovery page as a sectioned page with corresponding item listings within each section. Moreover, the display module 260 is to cause display of the generated discovery page on the client device.

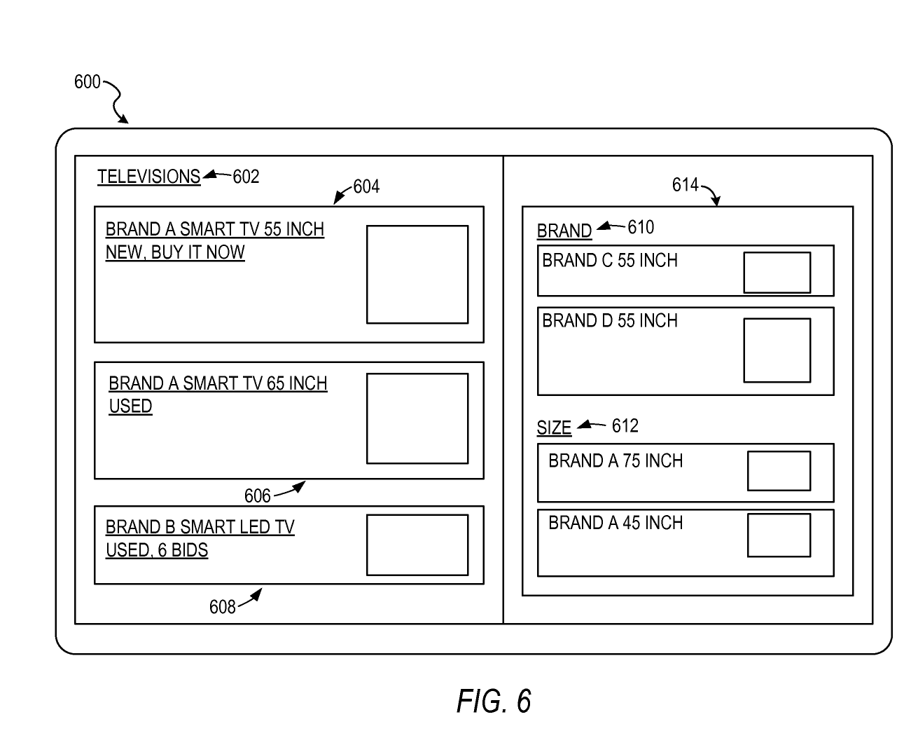

FIG. 6 is a diagram illustrating an example user interface 600 that includes a discovery page 614, according to some example embodiments. As shown in FIG. 6, the example user interface 600 is also a search results page that includes a description of a category 602 of items, a first search result 604, a second search result 606, and a third search result 608. The category of items is identified based on a query received from a client device. The example user interface 600 also includes the discovery page 614 with a section that corresponds to a first aspect 610 and a section that corresponds to a second aspect 612. The section that corresponds to the first aspect 610 displays item listings for items that fall within the described category 602 of items and that feature the first aspect 610. The section that corresponds to the second aspect 612 displays item listings for items that fall within the described category 602 of items and that feature the second aspect 612. Moreover, the item listings that feature the first aspect 610 and the item listings that feature the second aspect 612 are identified as being the most viewed items within the described category 602 of items.

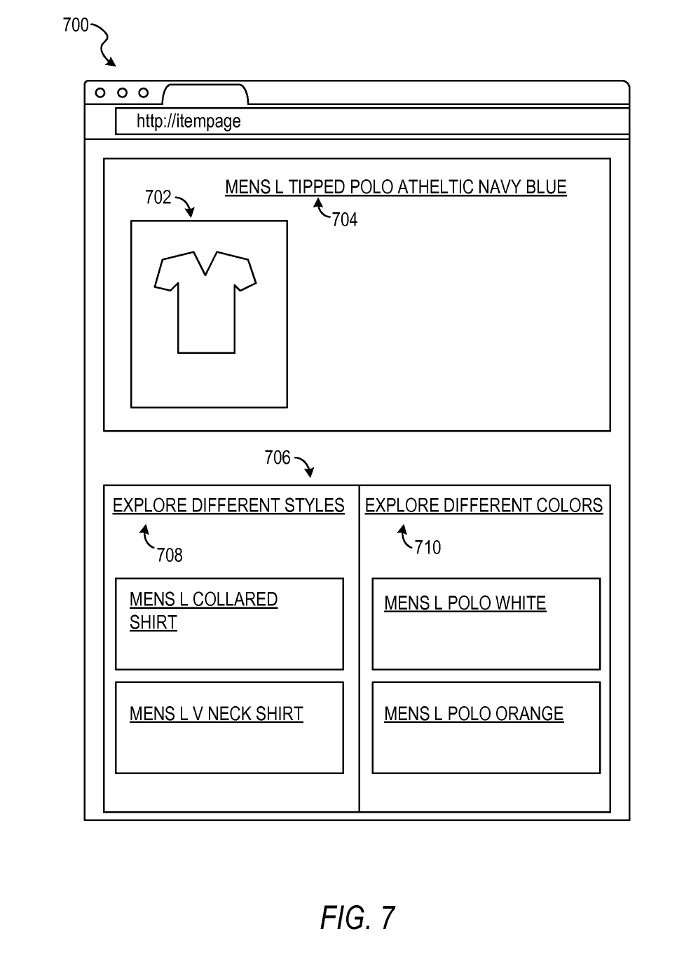

FIG. 7 is a diagram illustrating an example user interface 700 that includes a discovery page 706, according to some example embodiments. As shown in FIG. 7, a portion of the example user interface 700 is an item listing which includes a picture of an item 702 and a description 704 of the item. Another portion of the example user interface 700 is the discovery page 706, which includes a section that corresponds to a first aspect 708 and a section that corresponds to a second aspect 710. The section that corresponds to the first aspect 708 may display item listings for items that are similar to the item featured in the item page, but that are different from the item featured in the item page based on the aspect 708. The section that corresponds to the second aspect 710 may display item listings for items that are similar to the item featured in the item page, but that are different from the item featured in the item page based on the aspect 708.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

The modules, methods, applications and so forth described in conjunction with FIGS. 2-5 are implemented in some embodiments in the context of a machine and associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

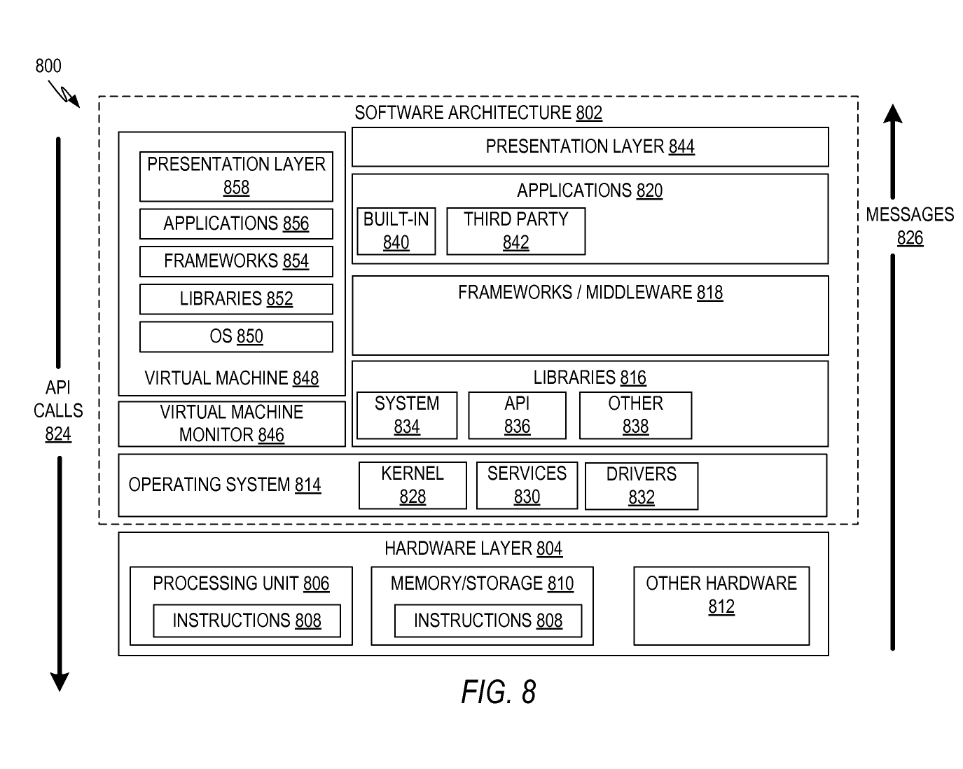

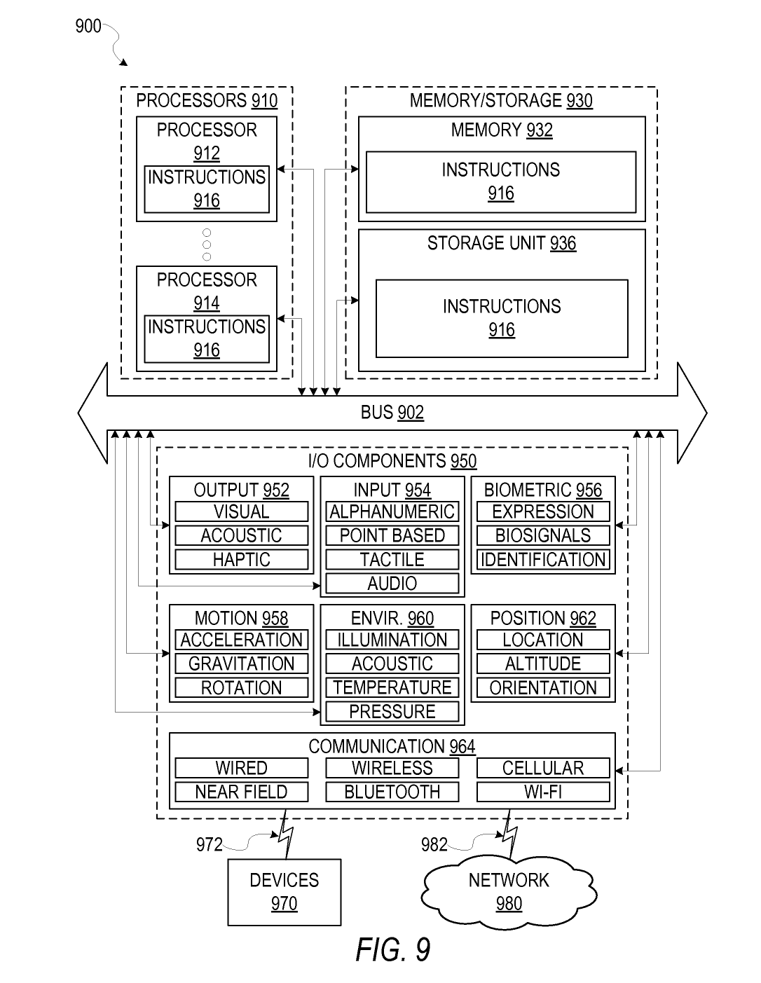

FIG. 8 is a block diagram 800 illustrating a representative software architecture 802, which may be used in conjunction with various hardware architectures herein described. FIG. 8 is merely a non-limiting example of a software architecture and it will be appreciated that many other architectures may be implemented to facilitate the functionality described herein. The software architecture 802 may be executing on hardware such as machine 900 of FIG. 9 that includes, among other things, processors 910, memory 930, and I/O components 950. A representative hardware layer 804 is illustrated and can represent, for example, the machine 900 of FIG. 9. The representative hardware layer 804 comprises one or more processing units 806 having associated executable instructions 808. Executable instructions 808 represent the executable instructions of the software architecture 802, including implementation of the methods, modules and so forth of FIGS. 2-5. Hardware layer 804 also includes memory and/or storage modules 810, which also have executable instructions 808. Hardware layer 804 may also comprise other hardware as indicated by 812 which represents any other hardware of the hardware layer 804, such as the other hardware illustrated as part of machine 900.

In the example architecture of FIG. 8, the software 802 may be conceptualized as a stack of layers where each layer provides particular functionality. For example, the software 802 may include layers such as an operating system 814, libraries 816, frameworks/middleware 818, applications 820 and presentation layer 844. Operationally, the applications 820 and/or other components within the layers may invoke application programming interface (API) calls 824 through the software stack and receive a response, returned values, and so forth illustrated as messages 826 in response to the API calls 824. The layers illustrated are representative in nature and not all software architectures have all layers. For example, some mobile or special purpose operating systems may not provide a frameworks/middleware layer 818, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830 and/or drivers 832). The libraries 816 may include system 834 libraries (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be utilized by the applications 820 and/or other software components/modules. For example, the frameworks 818 may provide various graphic user interface (GUI) functions, high-level resource management, high-level location services, and so forth. The frameworks 818 may provide a broad spectrum of other APIs that may be utilized by the applications 820 and/or other software components/modules, some of which may be specific to a particular operating system or platform.

The applications 820 includes built-in applications 840 and/or third party applications 842. Examples of representative built-in applications 840 may include, but are not limited to, a contacts application, a browser application, a book reader application, a location application, a media application, a messaging application, and/or a game application. Third party applications 842 may include any of the built in applications as well as a broad assortment of other applications. In a specific example, the third party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 842 may invoke the API calls 824 provided by the mobile operating system such as operating system 814 to facilitate functionality described herein.

The applications 820 may utilize built in operating system functions (e.g., kernel 828, services 830 and/or drivers 832), libraries (e.g., system 834, APIs 836, and other libraries 838), frameworks/middleware 818 to create user interfaces to interact with users of the system. Alternatively, or additionally, in some systems interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware machine (such as the machine of FIG. 9, for example). A virtual machine is hosted by a host operating system (operating system 814)and typically, although not always, has a virtual machine monitor 846, which manages the operation of the virtual machine as well as the interface with the host operating system (i.e., operating system 814). A software architecture executes within the virtual machine such as an operating system 850, libraries 852, frameworks/middleware 854, applications 856 and/or presentation layer 858. These layers of software architecture executing within the virtual machine 848 can be the same as corresponding layers previously described or may be different.

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example the instructions may cause the machine to execute the flow diagrams of FIGS. 3-5. Additionally, or alternatively, the instructions may implement the modules described in FIG. 2, and so forth. The instructions transform the general, non-programmed machine into a particular machine programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a personal digital assistant (PDA), a smart phone, a mobile device, smart devices, a web appliance, or any machine capable of executing the instructions 916, sequentially or otherwise, that specify actions to be taken by machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 912 and processor 914 that may execute instructions 916. The term “processor” is intended to include multi-core processor that may comprise two or more independent processors (sometimes referred to as “cores”) that may execute instructions contemporaneously. Although FIG. 9 shows multiple processors, the machine 900 may include a single processor with a single core, a single processor with multiple cores (e.g., a multi-core process), multiple processors with a single core, multiple processors with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of processors 910 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962 among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via coupling 982 and coupling 972 respectively. For example, the communication components 964 may include a network interface component or other suitable device to interface with the network 980. In further examples, communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a Universal Serial Bus (USB)).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as, location via Internet Protocol (IP) geo-location, location via Wi-Fi® signal triangulation, location via detecting a NFC beacon signal that may indicate a particular location, and so forth.

In various example embodiments, one or more portions of the network 980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to devices 970. The term “transmission medium” shall be taken to include any intangible medium that is capable of storing, encoding, or carrying instructions 916 for execution by the machine 900, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving a query that includes an identifier of an item from a client device;
identifying, using the identifier of the item, a category of items that includes the item described in the query;
determining one or more aspects that correspond to a group of items included in the category of items, the one or more aspects representing popular aspects within the category of items;
accessing item listings of the group of items from the category of items;
generating, using one or more processors, a discovery page that depicts the accessed item listings of the group of items in relation to the one or more aspects representing the popular aspects within the category of items; and
causing display of the generated discovery page on the client device.

2. The method of claim 1, wherein the causing the display of the generated discovery page includes causing display of the generated discovery page within a search results page for the query.

3. The method of claim 1, wherein the identifying the category of items includes determining that at least one item listing from the category of items received at least a predetermined threshold number of previous user views.

4. The method of claim 1, wherein the determining the one or more aspects that correspond to the group of items includes determining that the item listings for the group of items received a greater number of previous user views as compared to item listings of items outside of the group of items.

5. The method of claim 1, further comprising:
receiving a request to view an item page for the item described in the query;
accessing the item page for the item described in the query;
identifying one or more aspects of the item from the item page; and
accessing item listings of a further group of items from the category of items that correspond to the identified one or more aspects from the item page,

6. The method of claim 5, wherein the generating the discovery page includes generating a discovery page that depicts the accessed item listings of the further group of items.

7. The method of claim 5, wherein the causing the display of the generated discovery page includes causing display of the generated discovery page within the requested item page.

8. The method of claim 1, wherein the generating the discovery page that depicts the accessed item listings of the group of items in relation to the one or more aspects includes arranging the accessed item listings of the group of items in the discovery page based on the one or more aspects.

9. The method of claim 1, wherein the determining one or more aspects includes determining a restricted aspect based on the item described in the query.

10. The method of claim 1, wherein the one or more aspects that correspond to the group of items includes at least one of a brand, a style, a color, a type, or a size.

11. A system comprising:
a reception module configured to receive a query that includes an identifier of an item from a client device;
an identification module configured to identify, using the identifier of the item, a category of items that includes the item described in the query;
a determination module configured to determine one or more aspects that correspond to a group of items included in the category of items, the one or more aspects representing popular aspects within the category of items;
an access module configured to access item listings of the group of items from the category of items;
a generation module configured to generate a discovery page that depicts the accessed item listings of the group of items in relation to the one or more aspects representing the popular aspects within the category of items; and
a display module configured to cause display of the generated discovery page on the client device.

12. The system of claim 11, wherein the display module is further configured to cause display of the generated discovery page within a search results page for the query.

13. The system of claim 11, wherein the identification module is further configured to determine that at least one item listing from the category of items received at least a predetermined threshold number of previous user views.

14. The system of claim 11, wherein the determination module is further to determine that the item listings for the group of items received a greater number of previous user views as compared to item listings of items outside of the group of items.

15. The system of claim 11, wherein the reception module is further configured to receive a request to view an item page for the item described in the query, wherein the access module is further configured to access the item page for the item described in the query, wherein the identification module is further configured to identify one or more aspects of the item from the item page, and wherein the access module is further configured to access item listings of a further group of items from the category of items that correspond to the identified one or more aspects from the item page.

16. The system of claim 15, wherein the generation module is further configured to generate a discovery page that depicts the accessed item listings of the further group of items.

17. The system of claim 15, wherein the display module is further configured to cause display of the generated discovery page within the requested item page.

18. The system of claim 11, wherein the generation module is further configured to arrange the accessed item listings of the group of items in the discovery page based on the one or more aspects.

19. The system of claim 11, wherein the determination module is further configured to determine a restricted aspect based on the item described in the query.

20. A non-transitory machine-readable medium storing instructions that, when executed by one or more processors of a machine, cause the machine to perform operations comprising:
receiving a query that includes an identifier of an item from a client device;
identifying, using the identifier of the item, a category of items that includes the item described in the query;
determining one or more aspects that correspond to a group of items included in the category of items, the one or more aspects representing popular aspects within the category of items;
accessing item listings of the group of items from the category of items;
generating a discovery page that depicts the accessed item listings of the group of items in relation to the one or more aspects representing the popular aspects within the category of items; and
causing display of the generated discovery page on the client device.
